(19) United States
(12) Patent Application Publication
(10) Pub. No.: US 2017/0262851 A1
(43) Pub. Date: Sep. 14, 2017

(54) RISK DATA MODELING

(71) Applicant: WEPAY, INC., Palo Alto, CA (US)

(72) Inventor: John R. CANFIELD, San Carlos, CA (US)

(73) Assignee: WEPAY, INC., Palo Alto, CA (US)

(21) Appl. No.: 14/911,901

(22) PCT Filed: Jun. 11, 2015
(86) PCT No.: PCT/US2015/035320

§ 371 Date: Feb. 12, 2016

Related U.S. Application Data
(60) Provisional application No. 62/010,939, filed on Jun. 11, 2014.

(51) Int. Cl. G06Q 20/40

(52) U.S. Cl. CPC G06Q 20/4016

(57) ABSTRACT

A system includes a computing device that receives risk variables associated with risk data and that associates the risk variables with a plurality of nodes such that each of the risk variables corresponds to a separate node. The computing device analyzes the nodes to identify a level of consistency or a level of inconsistency for each of the nodes and creates a plurality of links such that each of the links connects a separate node with at least one associated related node. The computing device uses each of the links to record data related to the level of consistency or the level of inconsistency identified for the corresponding connected nodes, wherein each of the links corresponds to separate recorded data. The computing device provides a score for each of the links based on the corresponding recorded data and determines the threat of a viable risk based on the provided score.

### RELATED AND CO-PENDING APPLICATION

This application claims the benefit of U.S. Provisional Patent Application No. 62/010,939 filed on Jun. 11, 2014, the contents of which are incorporated herein by reference in their entirety.

### BACKGROUND

The field of the disclosure described herein relates generally to risk data modeling and, more particularly, to systems and methods for analyzing risk data.

Many systems, using computing devices, enable payment transactions or services over a network. For example, at least some known platforms serve as marketplaces, such as Care.com, crowdfunding sites, such as GoFundMe, or business or invoice tool providers, such as FreshBooks.com. Such known platforms do not typically receive payments for themselves. Instead, they facilitate transactions and payments between their customers—a payee and a payer, wherein the payee can be a business selling goods or services, an event organizer, a non-profit, a club or organization, or an individual raising funds for personal needs, and the payer can be a customer of the payee. For example, FreshBooks.com can be a platform that provides accounting services, such as sending out invoices that the payee can use for submission to the payer.

Providing such services can be challenging for the platform due to the risks associated with it, such as chargeback risks and/or fraud, and the complexity surrounding risk management. At least some known risk management systems can collect and verify a wide variety of data points about the payer, payee and transaction. These data points can be inputted into a decisioning system that uses rules and/or models to make the best possible decision on whether to accept or decline a transaction. Although some risk data can be collected from third party data sources, some data may still need to be collected and verified directly with the user. As such, the entity responsible for risk management may directly interact with the user.

At least some known platforms would prefer to outsource payment risk management and not invest in the costly personnel and technology needed. However, many platforms also want to control all interactions with their customers or users. As such, the platforms have a dilemma as to whether to control all user interaction and take on responsibility for risk management, or to give up control and outsource risk management to their payment provider. Another dilemma for platforms is deciding who has the best data to make payment risk decisions. For example, the payments provider has payment related data and expertise in payments risk. On the other hand, the platform has data about their customers that is unique to them, like feedback scores, detailed information about the transaction and in some cases personal knowledge. At least some known platforms also have a dilemma because they need to make decisions important to the trust and safety of their platform that go beyond payment risk. In addition, the platforms need to be able to effectively store and analyze the risk data that they receive.

### BRIEF DESCRIPTION

In some embodiments, the system described herein enables a risk management service provider (“service provider”) to work with a platform (“client member”) such that the service provider can receive relevant information about the users of the platform or client member, such as a payee (“primary user”) and a payer (“end user”) and the service provider is enabled to store and analyze the relevant information for decisioning. For example, in some embodiments, a system is provided that includes a computing device that can be used by the service provider, wherein the computing device is configured to receive relevant information, such as a plurality of risk variables that are associated with risk data. The computing device is configured to associate the risk variables with a plurality of nodes such that each of the risk variables corresponds to a separate node. The computing device is further configured to analyze each of the nodes to identify a level of consistency or a level of inconsistency for each of the nodes and to create a plurality of links such that each of the links connects a separate node with at least one associated related node. The computing device is configured to use each of the links to record data related to the level of consistency or the level of inconsistency identified for the corresponding connected nodes, wherein each of the links corresponds to separate recorded data. The computing device is also configured to provide a score for each of the links based on the corresponding recorded data and to determine the threat of a viable risk based on the provided score of each of the plurality of links.

In some embodiments, a method for analyzing risk data is provided, wherein the method includes transmitting a plurality of risk variables that are associated with risk data to a computing device. The risk variables are associated, via the computing device, with a plurality of nodes such that each of the risk variables corresponds to a separate node. Each of the nodes is analyzed to identify a level of consistency or a level of inconsistency for each of the nodes. A plurality of links are created such that each of the links connects a separate node with at least one associated related node. Each of the links is used to record data related to the level of consistency or the level of inconsistency identified for the corresponding connected nodes, wherein each of the links corresponds to separate recorded data. A score for each of the links is provided based on the corresponding recorded data. The threat of a viable risk is determined based on the provided score of each of the links.

In some embodiments, at least one computer-readable storage medium having computer-executable instructions embodied thereon is provided, wherein, when executed by at least one processor, the computer-executable instructions cause the processor to receive a plurality of risk variables that are associated with risk data and to associate the risk variables with a plurality of nodes such that each of the risk variables corresponds to a separate node. The computer-executable instructions also cause the processor to analyze each of the nodes to identify a level of consistency or a level of inconsistency for each of the nodes and to create a plurality of links such that each of the links connects a separate node with at least one associated related node. The computer-executable instructions further cause the processor to use each of the links to record data related to the level of consistency or the level of inconsistency identified for the corresponding connected nodes, wherein each of the links corresponds to separate recorded data. The computer-executable instructions cause the processor to provide a score for each of the links based on the corresponding recorded data and to determine the threat of a viable risk based on the provided score of each of the links.

### BRIEF DESCRIPTION OF THE DRAWINGS

FIG. 1 is a block diagram of an exemplary system that includes a risk management service provider (“service provider”) that includes one or more computing devices, one or more platforms (“client members”), one or more payees (“primary users”), and one or more payers (“end users”); and

FIG. 2 is a flow diagram of an exemplary method for analyzing risk data using the system shown in FIG. 1.

### DETAILED DESCRIPTION

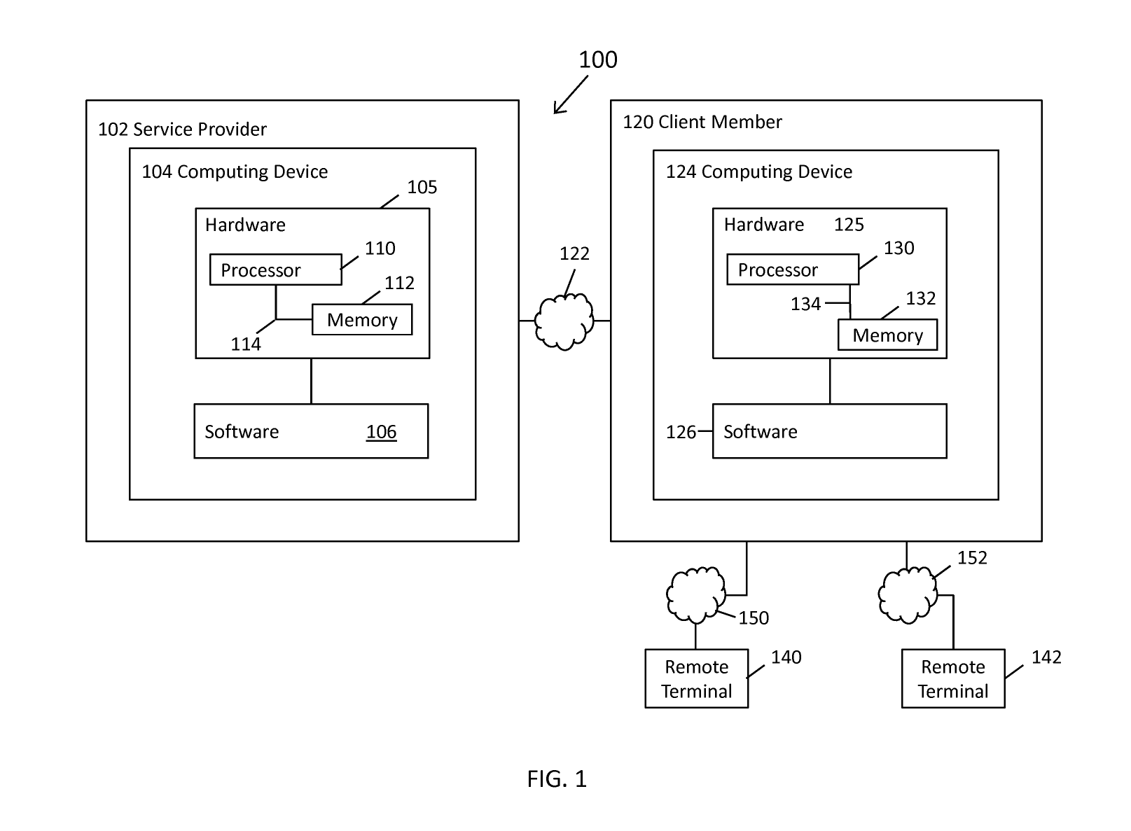

FIG. 1 illustrates an exemplary system 100 that includes that includes a risk management service provider (“service provider”) 102 that includes one or more computing devices or hosts 104. In the some embodiments, computing device 104 includes a hardware unit 105 and software 106. Software 106 can run on hardware unit 105 such that various applications or programs can be executed on hardware unit 105 by way of software 106. In some embodiments, the functions of software 106 can be implemented directly in hardware unit 105, e.g., as a system-on-a-chip, firmware, field-programmable gate array (FPGA), etc. In some embodiments, hardware unit 105 includes one or more processors, such as processor 110. In some embodiments, processor 110 is an execution unit, or “core,” on a microprocessor chip. In some embodiments, processor 110 may include a processing unit, such as, without limitation, an integrated circuit (IC), an application specific integrated circuit (ASIC), a microcomputer, a programmable logic controller (PLC), and/or any other programmable circuit. Alternatively, processor 110 may include multiple processing units (e.g., in a multi-core configuration). The above examples are exemplary only, and, thus, are not intended to limit in any way the definition and/or meaning of the term “processor.”

Hardware unit 105 also includes a system memory 112 that is coupled to processor 110 via a system bus 114. Memory 112 can be a general volatile random access memory (RAM). For example, hardware unit 105 can include a 32 bit microcomputer with 2 Mbit ROM and 64 Kbit RAM, and/or a few GB of RAM. Memory 112 can also be a read-only memory (ROM), a network interface (NIC), and/or other device(s). In some embodiments, computing device 104 can also include at least one media output component (not shown) for use in presenting information to a user. The media output component can be any component capable of conveying information to a user and may include, without limitation, a display device (not shown) (e.g., a liquid crystal display (LCD), an organic light emitting diode (OLED) display, or an audio output device (e.g., a speaker or headphones)).

In some embodiments, computing device 104 includes an input or a user interface (not shown) for receiving input from a user. The input interface may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of the media output component and the input interface.

In some embodiments, service provider 102 can be connected to one or more platforms (“client member”) 120 (only one being shown in FIG. 1) via, for example, a network 122. Network 122 can be the Internet, a local area network (LAN), a wide area network (WAN), a personal area network (PAN), or any combination thereof, and network 122 can transmit information between service provider 102 and client member 120. Client member 120 can be, for example, a platform that serves as a marketplace, a crowdfunding sites, and/or a business or invoice tool provider.

Similar to service provider 102, client member 120 can also include a computing device 124 that includes a hardware unit 125 and software 126. Software 126 can run on hardware unit 125 such that various applications or programs can be executed on hardware unit 125 by way of software 126. In some embodiments, the functions of software 126 can be implemented directly in hardware unit 125, e.g., as a system-on-a-chip, firmware, FPGA, etc. In some embodiments, hardware unit 125 includes one or more processors, such as processor 130. In some embodiments, processors 130 is an execution unit, or “core,” on a microprocessor chip. In some embodiments, processors 130 may include a processing unit, such as, without limitation, an IC, an ASIC, a microcomputer, a PLC, and/or any other programmable circuit. Alternatively, processor 130 may include multiple processing units (e.g., in a multi-core configuration). The above examples are exemplary only, and, thus, are not intended to limit in any way the definition and/or meaning of the term “processor.”

Hardware unit 125 also includes a system memory 132 that is coupled to processor 130 via a system bus 134. Memory 132 can be a general volatile RAM. For example, hardware unit 125 can include a 32 bit microcomputer with 2 Mbit ROM and 64 Kbit RAM. Memory 132 can also be a ROM, a NIC, and/or other device(s). In some embodiments, computing device 124 can also include at least one media output component (not shown) for use in presenting information to a user. The media output component (not shown) can be any component capable of conveying information to a user and may include, without limitation, a display device (not shown) (e.g., a LCD, an OLED display, or an audio output device (e.g., a speaker or headphones)).

In some embodiments, computing device 124 includes an input or a user interface (not shown) for receiving input from a user. The input interface may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of the media output component and input interface.

In some embodiments, one or more users may connect to, and interact with client member 120 by using separate remote terminals. For example, in some embodiments, one or more payees (“primary users”) such as, for example, a business selling goods or services, an event organizer, a non-profit, a club or organization, or an individual raising funds for a personal needs, can connect to client member 120 by using one or more remote terminals 140 (only being shown in FIG. 1). Similarly, one or more payers (“end users”), such as a customer of the payee(s), can connect to client member 120 by using one or more remote terminals 140 and 142 (only two being shown in FIG. 1).

Each remote terminal 140 and 142 can be capable of communicating with client member 120 via separate networks 150 and 152, respectively. Each network 150 and 152 can be the Internet, a LAN, a WAN, a PAN, or any combination thereof, and each network 150 and 152 can transmit information between client member 120 and remote terminal terminals 140 and 142, respectively, at different rates or speeds. Remote terminals 140 and 142 can each be a desktop computer, laptop, mobile device, tablet, thin client, or other device having a communications interface (not shown). In some embodiments, each remote terminal 140 and 142 can also be capable of receiving user input from the primary user and the end user, respectively, and transmitting the received input to client member 120.

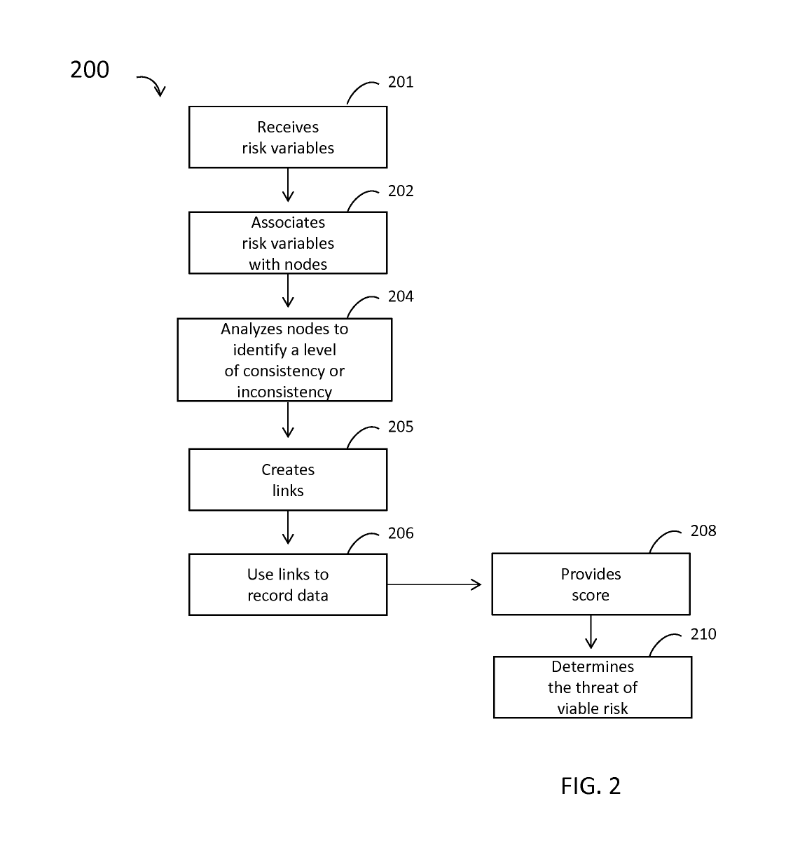

During operation of system 100, as described in more detail below with respect to FIG. 2, service provider 102, via computing device 104, can receive risk data from various sources, such as from client member 120, the primary users, and/or from third parties (not shown). Service provider 102, via computing device 104, can then store and/or analyze the risk data to identify the threat of viable risks that may be, for example, indicative of fraud and/or identity theft.

FIG. 2 is a flow diagram 200 of an exemplary method for analyzing risk data using a, such as computing device 104 (shown in FIG. 1) in system 100 (shown in FIG. 1). This method may be embodied within a plurality of computer-executable instructions stored in one or more memories, such as one or more computer-readable storage mediums. Computer storage mediums include non-transitory media and may include volatile and nonvolatile, removable and non-removable mediums implemented in any method or technology for storage of information such as computer-readable instructions, data structures, program modules or other data. The instructions may be executed by one or more processors to perform the functions described herein.

In step 201, service provider 102 (shown in FIG. 1), using computing device 104, receives a plurality of risk variables that are associated with risk data from various different sources, such as from client member 120 (shown in FIG. 1), primary users (not shown), and/or third parties (not shown). For example, in some embodiments, a primary user and an end user may undergo a transaction, at which time the primary user uses remote terminal 140 (shown in FIG. 1) and the end user uses remote terminal 142 (shown in FIG. 1) to establish a connection with client member 120 (shown in FIG. 1), and as such, the primary user and the end user can communicate with client member 120. Using remote terminal 140 and remote terminal 142, the primary user and the end user, respectively, can transmit data to client member 120, wherein the data can include various variables (i.e., risk variables such as the respective names of the primary user and the end user). In some embodiments, the type of variables that are communicated between the client member 120 and the primary user and/or the end user is the type of data that can be used to determine risk associated with the primary user and/or the end user. For example, the different types of data can include personal name, employer, title, birthdate, business name, email address, physical address, phone number, tax identification number, industry code, business description, business website URL, external accounts (partner user account, account information for social media sites, etc.), other website content, including reviews, revenue, business legal structure, credit reports, other documents (business licenses, etc.), personal conversations/meeting notes, device information, verification information (e-mail verification, bank verification, etc.), risk review information, transaction details, including receipt/invoice and shipping details. In some embodiments, some information can be generated by client member 120 themselves. For example, client member 120 can do an assessment of the risk of the primary user and pass the result of that risk assessment to service provider 132.

For some users, there may be only a few data elements, but for others there may be many data elements. Even within a single data type, there may be multiple versions. For example, a small online business may have many different physical addresses associated with them: address of incorporation (possibly the address of their incorporation agent), home office addresses for some of their key employees, official mailing PO Box or vanity address, address of the warehouse where some of their operations take place. Each of these addresses may be associated with a different touch-point. For example, the address of incorporation appears on various legal documents, but the warehouse address may appear on their credit report. The riskiness of the business can be assessed when these multiple addresses are known, put in the right context and verified. The same is true with people, phone numbers, email addresses, websites, and most of the data types identified above. Upon receiving the data, client member 120 can save the data (i.e., the variables) within a database (not shown) within computing device 124 (shown in FIG. 1) and/or transmit the data to service provider such that service provider 102 can analyze the data.

In step 202, computing device 104 associates the plurality of risk variables with a plurality of nodes such that each of the risk variables corresponds to a separate node. In some embodiments, the nodes are nodes of atomic pieces of risk information, including but not limited to addresses, phone numbers, web content, etc. In some embodiments, the nodes are data nodes that are atomic pieces of risk information associated with an account, a user or a transaction, such as the classifications of nodes described in section 2 titled “Node data element” in U.S. Provisional Patent Application No. 62/010,939 filed on Jun. 11, 2014, the contents of which are incorporated herein by reference in their entirety. Additionally, the nodes can be verification nodes.

In step 204, computing device 104 analyzes each of the plurality of nodes to identify a level of consistency or a level of inconsistency for each of the nodes. For example, in some embodiments, computing device 104 can compare the nodes with previously stored data or data received from other sources to identify the consistency or inconsistency of the immediate node.

In step 205, computing device 104 creates a plurality of links such that each of the links connects a separate node with at least one associated related node. In step 206, computing device 104 uses each of the links to record data related to the level of consistency or the level of inconsistency identified for the corresponding connected nodes, wherein each of the links corresponds to separate recorded data. In some embodiments, when performing steps 205 and 206, computing device 104 uses, for example, data_link objects to establish relationships between risk nodes which drive the risk scoring of nodes, users, accounts, and/or transactions.

Unlike cross_links, data_links are linking data associated with a single user and/or account. For example, a user can synthesize an address that they submit to a site. But as the address gets more links, the chance it is synthesized decreases. For example, the following address can be difficult to synthesize: Is linked to the business name in KYC, the phone that is linked to the address is verified for control using delivery of a PIN to that phone number, the address shows up in third party web sites, and a street view of the address shows a store-front bearing the business' name. In some embodiments, computing device 104 can use information linking two or more risk_info objects together within a single user or account. Examples of link object properties are described in U.S. Provisional Patent Application No. 62/010,939 filed on Jun. 11, 2014, the contents of which are incorporated herein by reference in their entirety.

In some embodiments, automatically establishing links wherever possible can increase the accuracy of risk scoring while reducing the amount of manual review work. Examples of data_link creating algorithms include linking for common sources in which multiple Risk_info objects are passed through a risk application program interface (“API”) from a common source and at similar times, and, as a result, can be automatically linked together. For example, client member 120 can pass information sourced from, for example, a Guidestar report on Jan. 10, 2014. The information is passed in three risk_info objects: a business_report, an address, and a tax_id object. These three risk_info nodes are all related because they came from the same Guidestar report and therefore they are linked. Similarly, the information inputted by a user in a single session can be linked (for example, KYC name, and address fields they entered at the same time).

In some embodiments, computing device 104 can determine whether at least one node has a corresponding identical node. Computing device 104 can create a single node when the corresponding identical node is identified by merging the node with the identified corresponding identical node. For example, if there are two identical copies of the exact same phone number under a single account, those nodes and their associated links can be combined into a single node.

In some embodiments, computing device 104 creates the links such that each of the links connects a separate verification node with at least one associated related data node. For example, client member 120 may pass a control_verification risk_info object for a phone number. Separately, that phone number may have been entered by a user in their KYC flow. A data_link can be established between the two nodes.

In some embodiments, the nodes can include a plurality of a first type of address and a plurality of a second type of address. The links can be created by computing device 104 such that each link connects a separate first type of address with at least one associated related second type of address based on geolocation. For example, two addresses can be automatically linked based on how close they are to each other based on geolocation. An address and an IP address can also be linked by their distance based on geolocation. The same can apply to phone numbers or any other element that has a geographic location associated with it.

In some embodiments, an e-mail address and a web URL can be linked together if they share the same domain (excluding common domains, such as, for example, yahoo.com, etc). As part of fraud reviews, risk analysts can view, create, and edit both risk nodes and data links.

In step 208, computing device 104 provides a score for each of the links based on the corresponding recorded data. In some embodiments, computing device 104 uses a scoring rules engine that has access to risk nodes and links properties. The scoring engine can then have rules written to generate scores for any type of node or link based on its own properties and the properties of the connecting nodes and links. In some embodiments, computing device 104 uses and action rules engine that will have access to aggregate scoring as well as individual nodes and their properties.

When performing step 208, in some embodiments, the scores are associated with nodes, links, and verification. For example, the scores are expressed as exponents that then are translated into % probabilities, as shown in Table 1 below.

TABLE 1
Probability of Good = (2 \hat{ } score)/(1 + (2 \hat{ } score))

| Score | Probability |
|---|---|
| −10 | 0.1% |
| −9 | 0.2% |
| −8 | 0.4% |
| −7 | 0.8% |
| −6 | 1.5% |
| −5 | 3.0% |
| −4 | 5.9% |
| −3 | 11.1% |
| −2 | 20.0% |
| −1 | 33.3% |
| 0 | 50.0% |
| 1 | 66.7% |
| 2 | 80.0% |
| 3 | 88.9% |
| 4 | 94.1% |
| 5 | 97.0% |
| 6 | 98.5% |
| 7 | 99.2% |
| 8 | 99.6% |
| 9 | 99.8% |
| 10 | 99.9% |

Thus, a score of 10 translates to a 99.9% probability that an entity is good (will not product loss), whereas a score of −10 translates to a 99.9% probability that an entity is bad (will produce loss). Scores can go higher than 10 or lower than −10.

In step 210, computing device 210 determines the threat of a viable risk based on the provided score of each of the links. For example, in some embodiments, service provider 102 can compare the score with existing scores in the database or information received from third parties and identify whether there are any inconsistencies with the variable. In some embodiments, service provider 102 can then transmits a notification to client member 120 if a risk is determined. For example, in some embodiments, service provider 102 can transmit an email to client member 120 regarding the risk. In some embodiments, a notification can be can be sent to provide notification that no risk has been determined. In some embodiments, service provider 102 provides the notification to client member 120 via an application program interface using computing device 104. In some embodiments, a transaction can be directly cancelled or apply risk controls (like canceling a payment or requiring a user to go through additional authorization) can be implemented. In such cases, a notification can be sent, by e-mail, to the primary user or end user as well (with either the service provider or client member branding). As such, not all actions based on risk score need to involve client member 120.

Exemplary embodiments of systems and methods are described above in detail. The systems and methods are not limited to the specific embodiments described herein, but rather, components of each system and/or method may be utilized independently and separately from other components described herein. For example, each system may also be used in combination with other systems and is not limited to practice with only systems as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising a computing device that is configured to:
receive a plurality of risk variables that are associated with risk data;
associate the plurality of risk variables with a plurality of nodes such that each of the plurality of risk variables corresponds to a separate node;
analyze each of the plurality of nodes to identify a level of consistency or a level of inconsistency for each of the plurality of nodes;
create a plurality of links such that each of the plurality of links connects a separate node of the plurality of nodes with at least one associated related node;
use each of the plurality of links to record data related to the level of consistency or the level of inconsistency identified for the corresponding connected nodes, wherein each of the plurality of links corresponds to separate recorded data;
provide a score for each of the plurality of links based on the corresponding recorded data; and
determine the threat of a viable risk based on the provided score of each of the plurality of links.

2. A system in accordance with claim 1, wherein the plurality of nodes are associated with one of an account, a user, or a transaction.

3. A system in accordance with claim 1, wherein said computing device is further configured to:
determine whether at least one node of the plurality of nodes has a corresponding identical node; and
create a single node when the corresponding identical node is identified by merging the at least one node with the identified corresponding identical node.

4. A system in accordance with claim 1, wherein the plurality of nodes includes a plurality of verification nodes and a plurality of data nodes.

5. A system in accordance with claim 4, wherein said computing device is configured to create the plurality of links by being configured to create the plurality of links such that each of the plurality of links connects a separate verification node of the plurality of verification nodes with at least one associated related data node.

6. A system in accordance with claim 1, wherein the plurality of nodes includes a plurality of a first type of address and a plurality of a second type of address.

7. A system in accordance with claim 6, wherein said computing device is configured to create the plurality of links by being configured to create the plurality of links such that each of the plurality of links connects a separate first type of address of the plurality of first type of address with at least one associated related second type of address based on geolocation.

8. A method for analyzing risk data, wherein said method comprises:
transmitting a plurality of risk variables that are associated with risk data to a computing device;
associating the plurality of risk variables, via the computing device, with a plurality of nodes such that each of the plurality of risk variables corresponds to a separate node;
analyzing each of the plurality of nodes to identify a level of consistency or a level of inconsistency for each of the plurality of nodes;
creating a plurality of links such that each of the plurality of links connects a separate node of the plurality of nodes with at least one associated related node;
using each of the plurality of links to record data related to the level of consistency or the level of inconsistency identified for the corresponding connected nodes, wherein each of the plurality of links corresponds to separate recorded data;
providing a score for each of the plurality of links based on the corresponding recorded data; and
determining the threat of a viable risk based on the provided score of each of the plurality of links.

9. A method in accordance with claim 8, wherein the plurality of nodes are associated with one of an account, a user, or a transaction.

10. A method in accordance with claim 8, further comprising:
determining whether at least one node of the plurality of nodes has a corresponding identical node; and
creating a single node when the corresponding identical node is identified by merging the at least one node with the identified corresponding identical node.

11. A method in accordance with claim 8, wherein associating the plurality of risk variables with a plurality of nodes comprises associating the plurality of risk variables with a plurality of nodes that include a plurality of verification nodes and a plurality of data nodes.

12. A method in accordance with claim 11, wherein creating a plurality of links comprises creating a plurality of links such that each of the plurality of links connects a separate verification node of the plurality of verification nodes with at least one associated related data node.

13. A method in accordance with claim 8, wherein associating the plurality of risk variables with a plurality of nodes comprises associating the plurality of risk variables with a plurality of nodes that include a plurality of a first type of address and a plurality of a second type of address.

14. A method in accordance with claim 13, wherein creating a plurality of links comprises creating a plurality of links such that each of the plurality of links connects a separate first type of address of the plurality of first type of address with at least one associated related second type of address based on geolocation.

15. At least one computer-readable storage medium having computer-executable instructions embodied thereon, wherein, when executed by at least one processor, the computer-executable instructions cause the at least one processor to:
receive a plurality of risk variables that are associated with risk data;
associate the plurality of risk variables with a plurality of nodes such that each of the plurality of risk variables corresponds to a separate node;
analyze each of the plurality of nodes to identify a level of consistency or a level of inconsistency for each of the plurality of nodes;
create a plurality of links such that each of the plurality of links connects a separate node of the plurality of nodes with at least one associated related node;
use each of the plurality of links to record data related to the level of consistency or the level of inconsistency identified for the corresponding connected nodes, wherein each of the plurality of links corresponds to separate recorded data;
provide a score for each of the plurality of links based on the corresponding recorded data; and
determine the threat of a viable risk based on the provided score of each of the plurality of links.

16. At least one computer-readable storage medium in accordance with claim 15, wherein the computer-executable instructions further cause the at least one processor to:
determine whether at least one node of the plurality of nodes has a corresponding identical node; and
create a single node when the corresponding identical node is identified by merging the at least one node with the identified corresponding identical node.

17. At least one computer-readable storage medium in accordance with claim 15, wherein the plurality of nodes includes a plurality of verification nodes and a plurality of data nodes.

18. At least one computer-readable storage medium in accordance with claim 17, wherein the computer-executable instructions cause the at least one processor to create the plurality of links by causing the at least one processor to create the plurality of links such that each of the plurality of links connects a separate verification node of the plurality of verification nodes with at least one associated related data node.

19. At least one computer-readable storage medium in accordance with claim 15, wherein the plurality of nodes includes a plurality of a first type of address and a plurality of a second type of address.

20. At least one computer-readable storage medium in accordance with claim 19, wherein the computer-executable instructions cause the at least one processor to create the plurality of links by causing the at least one processor to create the plurality of links such that each of the plurality of links connects a separate first type of address of the plurality of first type of address with at least one associated related second type of address based on geolocation.
